(19) United States
(12) Patent Application Publication
(10) Pub. No.: US 2010/0171963 A1
(43) Pub. Date: Jul. 8, 2010

(54) APPARATUS FOR MEASUREMENT OF THREE-DIMENSIONAL SHAPE

(75) Inventors: Sang-yun Lee, Daejeon (KR); Min-gu Kang, Daejeon (KR); Ssang-gun Lim, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: INTEKPLUS CO., LTD, Daejeon (KR)

(21) Appl. No.: 12/601,973

(22) PCT Filed: May 28, 2008
(86) PCT No.: PCT/KR08/02968

§ 371 Date: Nov. 25, 2009

(30) Foreign Application Priority Data
May 29, 2007 (KR) 10-2007-0052290

(51) Int. Cl. G01B 11/25

(52) U.S. Cl. 356/610

(57) ABSTRACT

A 3D shape measuring apparatus is disclosed, which is capable of simultaneously obtaining interference fringes of the lowest point and the highest point, by comprising a reflection path controller that generates a reference plane reflection path equal to a reflection path from a lowest point, and a reference plane reflection path equal to a reflection path from a highest point, the lowest and the highest points of a measured object having a height difference.

### BACKGROUND OF THE INVENTION

1. Field of the Invention

The present invention relates to an apparatus for measuring three-dimensional (3D) shape of an object, and more particularly to a 3D shape measuring apparatus capable of simultaneously obtaining interference fringes regarding a lowest point and a highest point, by comprising a reflection path adjusting unit that generates a reference plane reflection path equal to a reflection path from a lowest point, and a reference plane reflection path equal to a reflection path from a highest point, the lowest and the highest points of a measured object having a height difference.

2. Description of the Related Art

There are various methods for measuring the shape of a fine surface of precise parts, including a stylus type method, a scanning electron microscope method, a scanning probe microscope method, a phase shifting interferometry method, a white-light scanning interferometry method, a confocal scanning microscope method and so on.

Usually, the above measuring methods measure a geometric shape on a 2D plane, such as a circle, a line, an angle and a line width, or detect a defect, foreign substances, asymmetry and the like of a pattern. Also, those measuring methods perform by applying a probe system comprising an optical microscope, an illuminator and a charge coupled device (CCD) represented by a CCD camera, and an image processing technology.

Among the above, the white-light scanning interferometry method and the phase shifting interferometry method are spotlighted as non-contact methods for measuring fine 3D shape, being widely used in measuring a semiconductor pattern, roughness of a surface of a soft material, a ball grid array (BGA), a laser marking pattern, a via hole and so on.

Although the two measuring methods are based on different principles, they can be implemented with the same optical and measuring system with only difference of whether to use multiple wavelength or monochromatic wavelength. Therefore, the two methods can compatibly be used in a commercialized measuring system.

The two measuring methods use an optical interference signal representing brightness of light in accordance with an optical path difference of two lights induced as the two lights simultaneously departing from a predetermined reference point are moved through different optical paths and then converged.

FIG. 4 shows the measuring principle of a general interferometer. The general interferometer operates in such a manner that a light emitted from a light source is split through a beam splitter and projected respectively to a reference plane, that is, a reference mirror and a measurement plane and then, the lights are reflected from the reference plane and the measurement plane and converged by the beam splitter.

An interference fringe thus generated by the convergence is detected by an optical detection device such as the CCD camera, accordingly calculating a phase of the interference fringe. Alternatively, a maximum coherence point may be extracted from an envelope of the interference fringe, thereby measuring the height.

Here, the interference fringe appears at a point where a distance from the beam splitter to the measurement plane corresponds to a distance from the beam splitter to the reference plane.

Accordingly, with regard to a measured object having the height difference, an interference fringe obtained section is uniformly split and the reference plane or the measured object is minutely transferred in each split section to thereby obtain the interference fringe. Next, a surface shape can be measured by composing a plurality of the interference fringes thus obtained.

Meanwhile, in case of the BGA, although the BGA also has 3D shape having a height difference, the surface shape or inferiority can be detected just by obtaining interference fringes with regard to the lowest point and the highest point.

However, in the above case, since the whole 3D shape cannot be measured by obtaining an image only once, it is required to obtain and compose interference fringes corresponding to the highest point and the lowest point so as to obtain a single interference fringe. Otherwise, it is required to obtain an interference fringe about the whole section from the highest point to the lowest point.

More specifically, one interference fringe is obtained by corresponding the distance from the beam splitter to the measured object to the distance from the beam splitter to the reference plane, and another interference fringe is obtained by corresponding a distance between the beam splitter and the highest point of the measured object to the distance between the beam splitter and the reference plane. In case of the white-light scanning interferometry method, the interference fringes need to be obtained throughout the whole section, that is, from a section wherein a distance between the beam splitter and the lowest point of the measured object corresponds to the distance between the beam splitter and the reference plane, to a section wherein the distance between the beam splitter and the highest point corresponds to the distance between the beam splitter and the reference plane.

As described above, according to the conventional art, it is inconvenient to obtain an interference fringe with regard to an object required to have the interference fringes of the lowest point and the highest point, such as a BGA, since images are respectively to be obtained regarding the lowest and the highest points and composed or the interference fringe needs to be obtained through the whole section.

Additionally, in a certain object, the highest point and the lowest point may have different reflectivity since being formed of different materials from each other, such as when the highest point is formed of metal having high reflectivity while the lowest point of a PCB having low reflectivity. If, in this case, reflectivity of the reference plane is set to one of the highest and the lowest points, measurement at the other point would not be favorably performed.

### SUMMARY OF THE INVENTION

Therefore, the present invention has been made in view of the above problems, and it is an object of the present invention to provide a 3D shape measuring apparatus that obtains an interference fringe from lights reflected by a surface of a measured object and a reference plane, the apparatus capable of obtaining interference fringes of a highest point and a lowest point simultaneously, by further equipping the reference plane with a reflection path adjusting unit having thickness equal to a height difference between the highest and the lowest points of the measured object.

It is another object of the present invention to provide a 3D shape measuring apparatus including an auxiliary beam splitter disposed in front of the reference plane to adjust the reflection path through fine driving thereof, or a plurality of beam splitters having different thicknesses and selectively brought to the front of the reference plane, such that the shape of an object having a height difference can be measured with a single device.

It is a further object of the present invention to provide a 3D shape measuring apparatus capable of accurately measuring even an object having different reflectivity between a highest point and a lowest point, by comprising reference planes having two reflection surfaces corresponding to a highest point reflection path and a lowest point reflection path of the object, and corresponding reflectivity of the two reflection surfaces to reflectivity of the highest point and the lowest point, respectively.

In accordance with the present invention, the above and other objects can be accomplished by the provision of a 3D shape measuring apparatus comprising a light source, a beam splitter splitting a light emitted from the light source, a measured object projected with the light from the light source, having a height difference between a highest point and a lowest point thereof, a reference plane projected with the light emitted from the beam splitter, a photographing device photographing an interference fringe formed by the lights reflected from a surface of the measured object and from the reference plane and composed, and a controlling computer processing the image photographed by the photographing device, wherein the reference plane further includes a reflection path adjusting unit which supplies reflection paths respectively equal to a reflection path from the highest point and a reflection path from the lowest point of the measured object.

The reflection path adjusting unit may comprise an auxiliary beam splitter having thickness equal to the height difference of the measured object, or an auxiliary beam splitter disposed between the beam splitter and the reference plane; and a fine actuator minutely driving the auxiliary beam splitter forward and backward. Furthermore, alternatively, the reflection path adjusting unit may comprise a plurality of auxiliary beam splitters having different thicknesses, being provided between the beam splitter and the reference plane to be selectively disposed in front of a reference plane.

Here, the auxiliary beam splitter may be capable of adjusting reflectivity corresponding to reflectivity of the highest point and reflectivity of the lowest point of the measured object.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a structural view of a 3D shape measuring apparatus according to a first embodiment of the present invention;

FIG. 2 is a structural view of a 3D shape measuring apparatus according to a second embodiment of the present invention;

FIG. 3 is a structural view of a 3D shape measuring apparatus according to a third embodiment of the present invention; and

FIG. 4 is a view illustrating a measurement principle of a general interferometer.

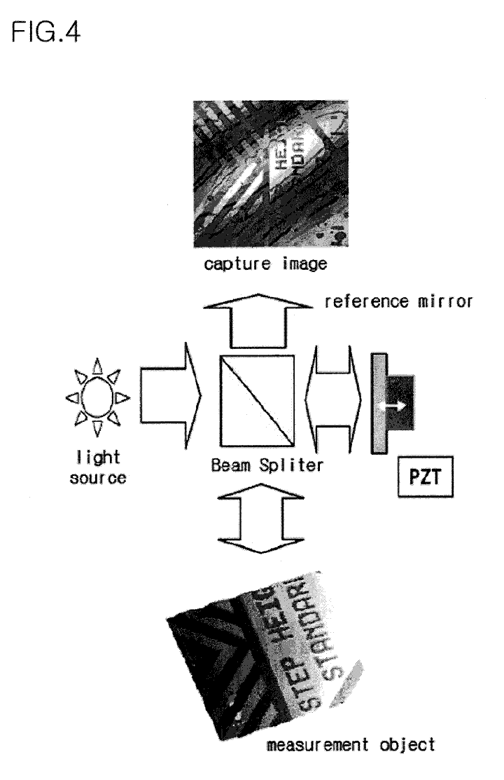

### DETAILED DESCRIPTION OF THE PREFERRED EMBODIMENTS

Hereinafter, exemplary embodiments of the present invention will be described in detail with reference to the accompanying drawings.

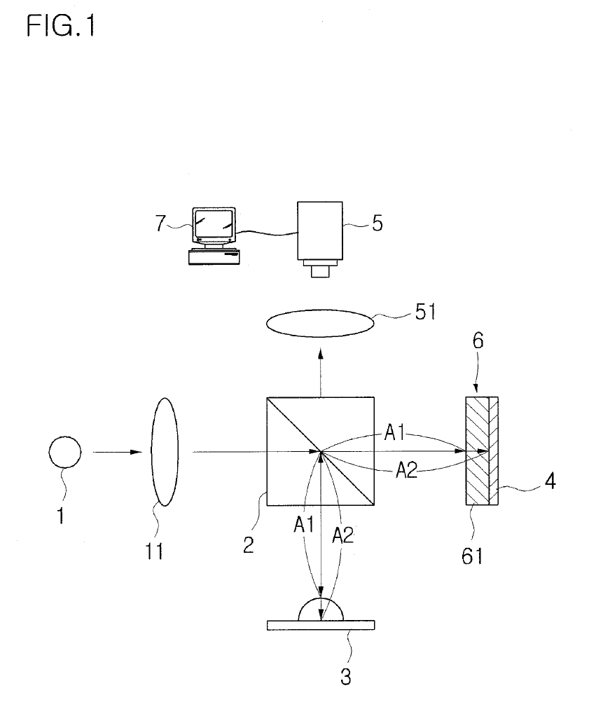

FIG. 1 is a structure view of a 3D shape measuring apparatus according to a first embodiment of the present invention.

Referring to FIG. 1, the measuring apparatus according to the first embodiment comprises a light source 1, a beam splitter 2, a measured object 3, a reference plane 4, a photographing device 5, and a controlling computer 7.

Here, the beam splitter 2 splits a light emitted from the light source so that the split lights are projected to surfaces of the reference plane 4 and the measured object 3, respectively, and then converges the lights being reflected from the measuring object 3 and the reference plane 4, thereby obtaining an interference fringe pattern. A projection lens is provided between the light source 1 and the beam splitter 2.

The measured object 3, which is projected with the light from the beam splitter 2, is an object having a height difference, for example, a BGA having a height difference between a highest point and a lowest point thereof.

The reference plane 4 is projected with the light split by the beam splitter 2. According to a distinctive feature of this embodiment, the reference plane 4 further includes a reflection path adjusting unit 6 that supplies reflection paths equal to a reflection path from the highest point and a reflection path from the lowest point of the measured object 3, respectively.

According to the first embodiment, an auxiliary beam splitter 61 having thickness equal to the height difference between the highest point and the lowest point of the measured object 3 is employed as the reflection path adjusting unit 6.

That is, the interference fringe is generated when a reflection path of the light from the beam splitter 2 to the measured object surface corresponds to a reflection path from the beam splitter 2 to the reference plane 4. Therefore, in order to obtain interference fringes with respect to the highest and the lowest points of the measured object 3 at one time, the reflection paths of the reference plane 4 which are the same as the lowest point reflection path and the highest point reflection path should respectively be generated.

More specifically, the auxiliary beam splitter 61 having thickness equal to the height of the measured object 3 is disposed in front of the reference plane 4, thereby generating the reference plane reflection paths same as the highest point reflection path A1 and the lowest point reflection path A2.

With the above structure, the measuring apparatus according to the first embodiment is capable of simultaneously obtaining an interference fringe by the sum of a reflection path A1 of the light reflected from the lowest point of the measured object 3 and a reflection path A1 of the light from the reference plane 4, and an interference fringe by the sum of a reflection path A2 of the light from a surface of the highest point of the measured object 3 and a reflection path A2 of the light from the auxiliary beam splitter 61 in front of the reference plane 4.

The photographing device 5 photographs patterns of the interference fringe formed by the lights reflected from the measured object 3 and the reference plane 4 and composed through the beam splitter 2. In addition, an imaging lens 51 is disposed between the beam splitter 2 and the photographing device 5.

The controlling computer 7 measures the height or 3D shape of the measured object using the images obtained by the photographing device 5. Also, the controlling computer 7 may detect inferiority through the measurement result.

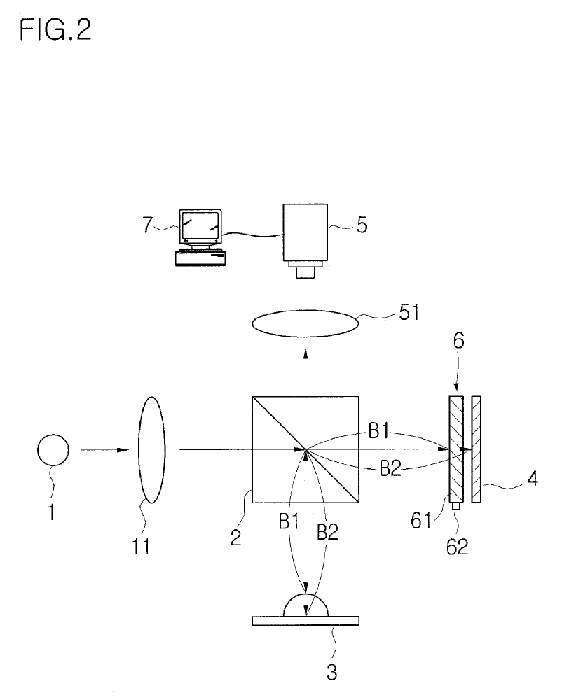

FIG. 2 shows the 3D shape measuring apparatus according to a second embodiment of the present invention. The same structures and operations as in the first embodiment will not be repeatedly explained.

Referring to FIG. 2, the reflection path adjusting unit 6 according to the second embodiment comprises the auxiliary beam splitter 61 disposed between the beam splitter 2 and the reference plane 4, and a fine actuator 62 minutely driving the auxiliary beam splitter 61 forward and backward.

As described above, according to the second embodiment of the present invention, a distance from the reference plane 4 to the measured object 3 can be adjusted in accordance with information on the height difference by using the auxiliary beam splitter 61 and the fine actuator 62.

That is, in case that the information on the height difference of the measured object 3 is changed, the highest point reflection path and the lowest point highest point are changed. Accordingly, the distance between the auxiliary beam splitter 61 and the reference plane 4 needs to be adjusted.

Therefore, the reflection path is properly adjusted by transferring the auxiliary beam splitter 61 forward or backward using the fine actuator 62 according to the changed information on the height difference.

Thus, although the height difference of the measured object 3 is changed, a reflection path B1 from the surface of the highest point of the measured object 3 and a reflection path B1 from the surface of the auxiliary beam splitter 61 are corresponded to each other and a reflection path B2 from the lowest point of the measured object 3 and a reflection path B2 from the reference plane 4 are corresponded to each other, by minutely driving the auxiliary beam splitter 61 by the fine actuator 62, thereby obtaining a lowest point interference fringe and a highest point interference fringe of the measured object 3 simultaneously.

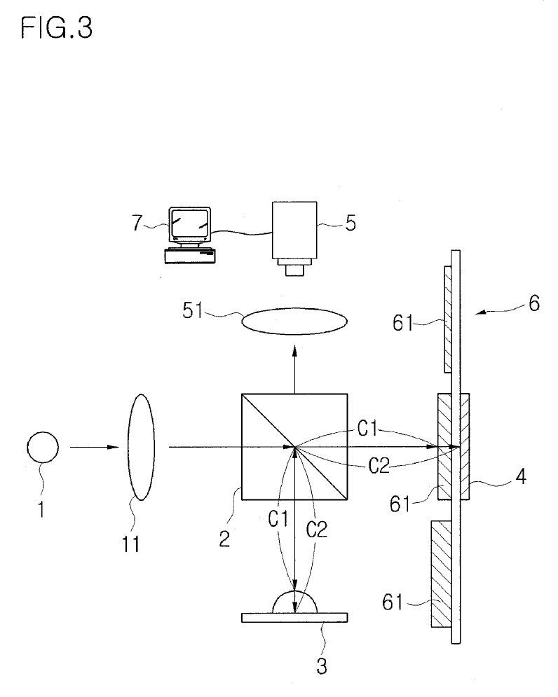

FIG. 3 shows a 3D shape measuring apparatus according to a third embodiment of the present invention. The same structures and operations of the third embodiment as in the previous embodiments will not be explained repeatedly.

Referring to FIG. 3, the reflection path adjusting unit 6 according to the third embodiment comprises a plurality of the auxiliary beam splitters 61 disposed between the beam splitter 2 and the reference plane 4 respectively, having different thicknesses from one another. The plurality of auxiliary beam splitters 61 are selectively disposed in front of the reference plane 4.

Here, the plurality of auxiliary beam splitters 61 may be mounted to a transparent plate according to the thickness, to be selectively disposed in front of the reference plane 4 by a dedicated driving unit such as a motor. However, the present invention is not limited to such a structure.

For example, although being in a vertical linear arrangement as mounted to the transparent plates in the third embodiment, the plurality of auxiliary beam splitters 61 may be in a horizontal linear arrangement. Furthermore, the auxiliary beam splitters 61 can be brought to the front of the reference plane 4 by being mounted to circular transparent plates and rotated by a dedicated driving unit, for example, a motor.

Additionally, although the auxiliary beam splitters 61 are mounted to the transparent plates in the drawing, the auxiliary beam splitters 61 may be mounted in open recesses (not shown) formed at rear sides of plates so as to prevent optical interference by the transparent plates.

Configuration of the plurality of auxiliary beam splitters 61 according to the third embodiment may be varied or modified.

Thus, the measuring apparatus according to the third embodiment of the present invention is advantageous in measuring various types of objects having different heights since using the plurality of auxiliary beam splitters 61 having respectively difference thicknesses. More specifically, the auxiliary beam splitter 61 is selected according to the height of the measured object 3 to be disposed in front of the reference plane 4, so as to correspond a reflection path C1 from the highest point of the measured object 3 to a reflection path C1 from a surface of the auxiliary beam splitter 61 and correspond a reflection path C2 from the lowest point of the measured object 3 to a reflection path C2 from the reference plane 4.

Accordingly, the lowest point interference fringe and the highest point interference fringe of the measured object 3 can be simultaneously obtained.

In the first to the third embodiments as described above comprising the auxiliary beam splitter 61 to have two reflection surfaces corresponding to the highest point reflection path and the lowest reflection path of the measured object, it is preferred that the auxiliary beam splitters 61 are able to adjust reflectivity corresponding to the reflectivity at the highest point and the lowest point.

Furthermore, although the embodiments of the present invention have been explained mainly focusing on the phase shifting interferometry (PSI) method that obtains the 3D shape by interpreting the interference fringes generated by a difference of reflection path, the present invention is not limited to the embodiments but can be applied to the white-light scanning interferometry (WSI) method that measures 3D shape of an object having a large height difference by detecting a position where the interference fringe becomes the maximum using a piezoelectric transducer (PZT), using restricted coherence of white light.

As apparent from the above description, the present invention provides a 3D shape measuring apparatus obtaining an interference fringe by composing lights reflected from a surface of a measured object and a reference plane, the measuring apparatus capable of improving speed and efficiency of the measurement by simultaneously obtaining an interference fringe of the highest point and an interference fringe of the lowest point of the measured object, by further comprising a reflection path adjusting unit having thickness equal to a height difference of the measured object.

In addition, by comprising an auxiliary beam splitter being disposed in front of the reference plane and capable of adjusting the reflection path through fine driving, or a plurality of beam splitters having different thicknesses and being selectively disposed in front of a reference plane, the 3D shape measuring apparatus is solely able to measure the shape of an object having a height difference. Thus, utility and measuring efficiency can be enhanced.

Furthermore, since the 3D shape measuring apparatus comprises reference planes having two reflection surfaces corresponding to a highest point reflection path and a lowest point reflection path of a measured object and corresponds reflectivity of the two reflection surfaces to reflectivity of the highest point and the lowest point, respectively, even an object having different reflectivity between a highest point and a lowest point can be accurately measured. That is, reliability of the measurement is enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A 3D shape measuring apparatus comprising:
a light source;
a beam splitter splitting a light emitted from the light source;
a measured object projected with the light from the light source, having a height difference between a highest point and a lowest point thereof;
a reference plane projected with the light emitted from the beam splitter;
a photographing device photographing an interference fringe formed by the lights reflected from a surface of the measured object and from the reference plane and composed;
and
a controlling computer processing the image photographed by the photographing device,
wherein the reference plane further includes a reflection path adjusting unit which supplies reflection paths respectively equal to a reflection path from the highest point and a reflection path from the lowest point of the measured object.

2. The 3D shape measuring apparatus according to claim 1, wherein the reflection path adjusting unit comprises an auxiliary beam splitter having thickness equal to the height difference of the measured object.

3. The 3D shape measuring apparatus according to claim 1, wherein the reflection path adjusting unit comprises an auxiliary beam splitter disposed between the beam splitter and the reference plane; and
a fine actuator minutely driving the auxiliary beam splitter forward and backward.

4. The 3D shape measuring apparatus according to claim 1, wherein the reflection path adjusting unit comprises a plurality of auxiliary beam splitters having different thicknesses, being provided between the beam splitter and the reference plane to be selectively disposed in front of a reference plane.

5. The 3D shape measuring apparatus according to claim 2, wherein the auxiliary beam splitter is capable of adjusting reflectivity corresponding to reflectivity of the highest point and reflectivity of the lowest point of the measured object.

6. The 3D shape measuring apparatus according to claim 3, wherein the auxiliary beam splitter is capable of adjusting reflectivity corresponding to reflectivity of the highest point and reflectivity of the lowest point of the measured object.

7. The 3D shape measuring apparatus according to claim 4, wherein the auxiliary beam splitter is capable of adjusting reflectivity corresponding to reflectivity of the highest point and reflectivity of the lowest point of the measured object.
